(19) United States
(12) Patent Application Publication
(10) Pub. No.: US 2008/0128345 A1
(43) Pub. Date: Jun. 5, 2008

(54) Unified Oil Filter and Cooler

(76) Inventor: Aleko D. Sotiriades, Cedarburg, WI (US)

Correspondence Address: WHYTE HIRSCHBOECK DUDEK S C, 555 EAST WELLS STREET, SUITE 1900, MILWAUKEE, WI, 53202, US

(21) Appl. No.: 11/564,877

(22) Filed: Nov. 30, 2006

(51) Int. Cl. B01D 35/18; B01D 37/00

(52) U.S. Cl. 210/184; 123/196 A; 210/767; 210/348

(57) ABSTRACT

A device which combines an engine oil cooler and oil filter such that oil flows through the inside of multiple flow channels formed between a ribbed housing wall and an interior baffle. Oil flowing through these chambers is cooled prior to passing through a replaceable filter media located interior of the baffle.

### FIELD OF THE INVENTION

The present invention relates to a device which combines an engine oil cooler and oil filter to save space and cost.

### BACKGROUND OF THE INVENTION

Many engines have an oil lubrication system that circulates oil to reduce friction between moving parts while the engine is in operation. During the circulation of the oil, the oil accumulates particulate debris, degraded oil, and also heats up from the heat of the engine. Therefore, the lubricating oil must be both filtered and cooled to provide proper protection to the engine parts. Most commonly, the filtering and the cooling are done as separate operations in different parts of the lubrication system. Separate filtering and cooling of the oil requires more space and is more expensive than cooling and filtering in a single unit.

A number of attempts have been made to provide a unified oil filter and cooler unit. Examples of such combined units can be found in U.S. Pat. Nos. 1,906,984; 3,887,467; 4,878,536; 4,923,603; 5,476,139; 5,740,772; and 6,261,448. An objective of the current invention is to improve upon these prior art combination oil filters and coolers by providing a unit that can replace a spin-on oil filter while providing for the use of a replaceable filter cartridge and which is also simple and cost efficient to manufacture.

### BRIEF SUMMARY OF THE INVENTION

In one embodiment, the invention is a unified oil filter and cooler comprising a hollow cylindrical housing adapted to receive an annular filter media within the housing. The housing comprises a sidewall and a removable first end cap and a second end cap, the first and second end caps disposed on opposite ends of the side wall, wherein the side wall comprises a multiplicity of hollow rib members. A baffle is interior of the housing and is in contact with the hollow rib members, wherein the baffle and each of the hollow rib members define separate rib flow channels. Multiple inlets are disposed on the second end cap. A first chamber is defined by the baffle, a portion of inside walls of the rib members, and an inside wall of the second end cap, wherein the first chamber is in fluid communication with the multiplicity of inlets and with the separate rib flow channels. A second chamber is present when an annular filter media is positioned within the housing. The second chamber is interior of the baffle and in fluid communication with the separate rib flow channels. The second chamber comprises an annular space defined by an interior side of the baffle and an exterior surface of the annular filter media. A third chamber is present when an annular filter media is positioned within the housing and comprises a space defined by an interior surface of the annular filter media, wherein the third chamber is in fluid communication with the second chamber through the filter media. An outlet is disposed on the second end cap, the outlet in fluid communication with the third chamber.

### BRIEF DESCRIPTION OF THE DRAWINGS

FIG. 1 shows an external view of one embodiment of the unified oil filter/cooler of the current invention.

FIG. 2 shows a side full cutaway view of the unified filter/cooler of FIG. 1.

FIG. 3 shows details of one embodiment of flow channels formed by hollow ribs of the unified filter/cooler of FIG. 1.

FIG. 4 shows an external view of one embodiment of fastening means for the unified filter/cooler of FIG. 1.

### DETAILED DESCRIPTION OF THE PREFERRED EMBODIMENT

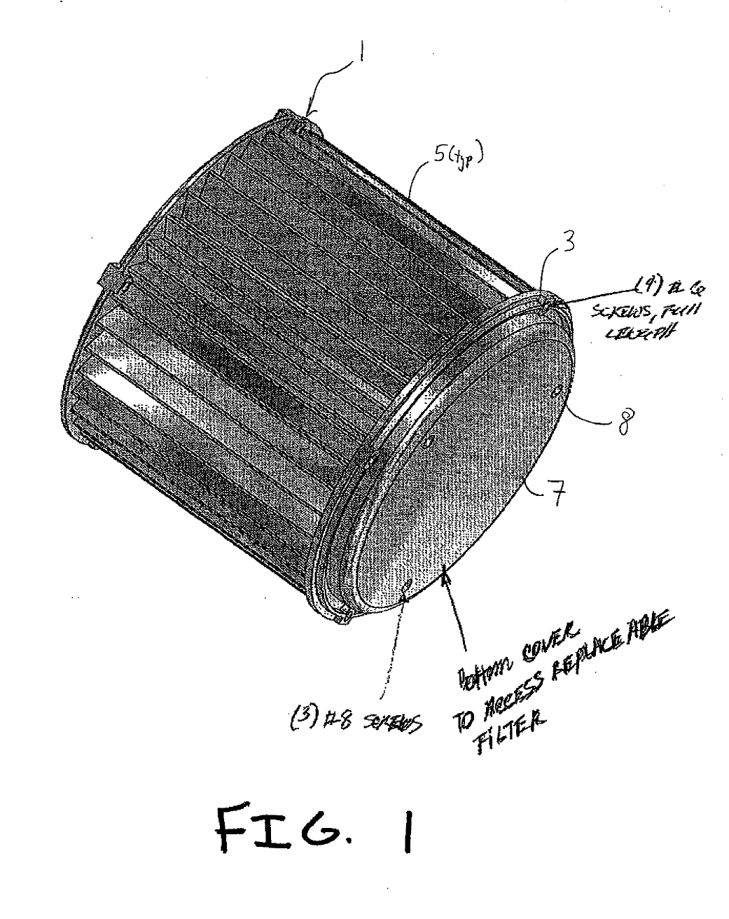

FIG. 1 shows an external view of one embodiment of the unified oil filter/cooler of the current invention. The filter/cooler comprises a housing 1 which has an annular sidewall 3. Sidewall 3 comprises a series of hollow rib members 5. Hollow rib members 5 can be any suitable configuration such as fins, ribs, or rounded or V-shaped corrugations (as shown). A bottom cover (or end cap) 7 is removably attached to housing 1 to provide access to replaceable filters positioned within the housing 1. Bottom cover 7 is attached to housing 1 by any suitable means, such as clamps, screw-on fittings or bolts 8 (as shown).

The housing 1 is preferably made from aluminum in order to be easily and inexpensively extruded or die cast. The housing shape approximates a finned tube to facilitate maximum heat transfer. The housing length and diameters are variable, such that the design can be scaled to an application. The all-aluminum structure possesses very high heat transfer coefficients as compared with typical steel construction of automotive filters.

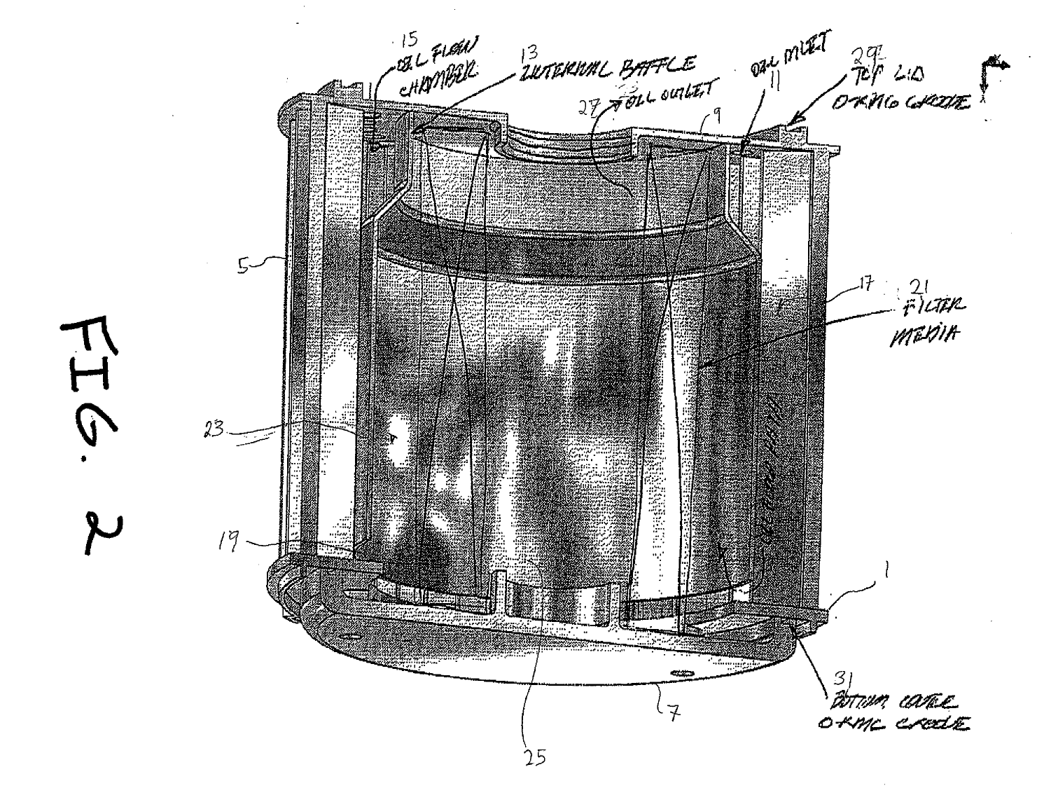

As shown in FIG. 2, a top lid 9 is also attached to housing 1. A number of oil inlet holes 11 perforate top lid 9 to provide access to the oil filter/cooler 21. Typically, the oil inlets 11 are arranged in a circular pattern, as shown, to provide for an even flow and pressure distribution.

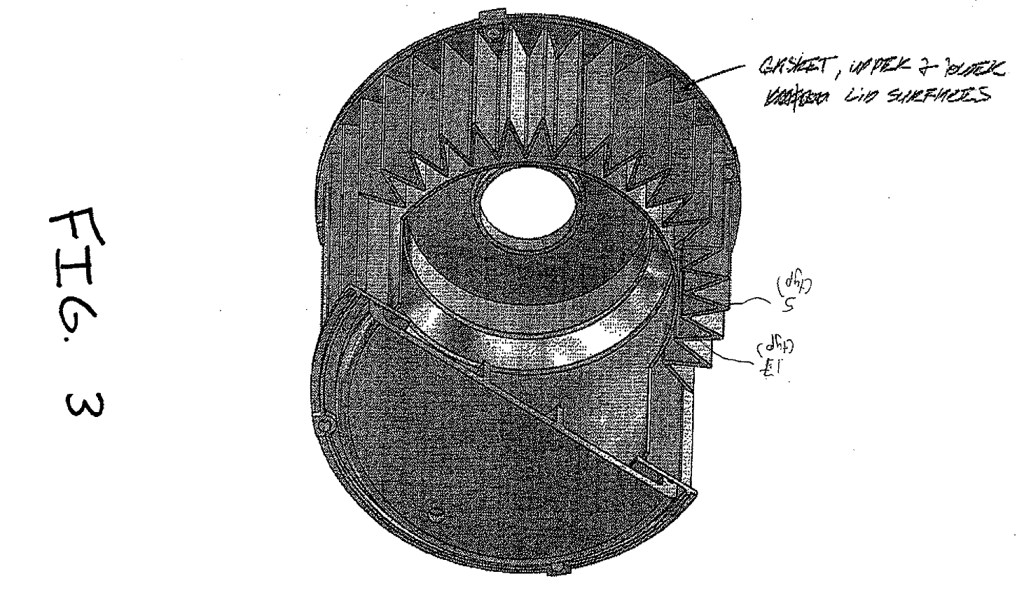

An internal baffle 13 is positioned within the housing 1 so as to be in contact with the inner surface of top lid 9 and also to contact portions of the inner surfaces of the rib members 5. The baffle 13 is configured so as to provide a first oil flow chamber 15 to receive the oil flowing in through oil inlets 11. The contact between baffle 13 and the inner surfaces of the rib members 5 defines separate oil flow channels 17. Oil flow channels 17 are further illustrated in FIG. 3. Returning to FIG. 2, the baffle is also configured to allow a spacing 19 between the end of the baffle and the inner surface of bottom cover 7.

An annular replaceable filter media 21 is placed within housing 1. A second oil flow chamber 23 is defined between baffle 13 and the filter media 21. A third oil flow chamber 25 is defined within the annulus formed by filter media 21. An oil outlet 27 provides fluid communication between the filter/cooler 21 and the engine lubrication system (not shown). The oil outlet 27 is preferably adapted to allow the filter/cooler 21 to attach to a spin-on oil filter mount.

O-ring grooves 29 and 31 are provided on the top lid 9 and bottom cover 7, respectively, to accommodate O-rings if necessary to achieve a fluid type seal when the covers are attached to the housing 1 and the filter/cooler 21 is installed in place.

When installed in place, the filter/cooler 21 operates as follows. Hot engine oil enters through a number, e.g., 32, of inlet ports of a mounting flange, separating the mass volume into individual flows. The oil flows are then chambered between the inside of a ribbed (corrugated cross section) housing wall 1 and an interior baffle 13. As oil flows along the housing wall 1, it gives up heat to the environment. The individual flows then terminate at the end of the housing length to an end plate and curve around to the interior side of the baffle and proceed to enter the filtering chamber together. In the filtering chamber, the oil passes through the external surface of a replaceable filtering element to an interior cavity, where it circulates back into the engine.

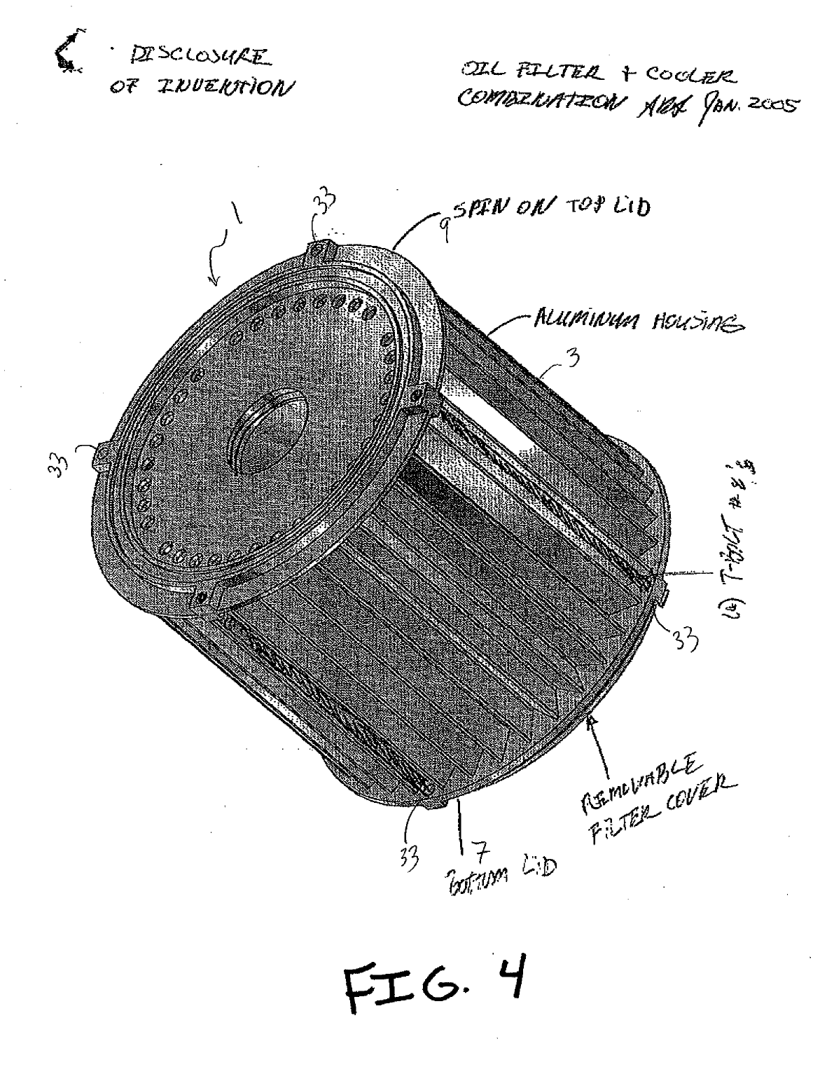

As shown in FIG. 4, the complete assembly may be held together by bolts or similar means. The embodiment shown uses four bolts 33 to cinch the housing 1 to the mounting and back plates with gaskets (not shown). If desired, even fewer could be used, for example, three clamping bolts 33 and two cover bolts 8. An alternative embodiment (not shown) does not use bolts and gaskets, rather the housing and plates are soldered together. In any of these embodiments, a useful advantage of the current invention over prior art devices is the reduced part count.

Attributes of the unified oil filter cooler are: Direct replacement to existing (spin-on) automotive engine oil filters, reduced engine oil temperature, a replaceable filter medium, variable diameter and/or length construction, reusable body and shell, low manufacturing cost and variable assembly methods.

It is specifically intended that the present invention not be limited to the embodiments and illustrations contained herein, but include modified forms of those embodiments including portions of the embodiments and combinations of elements of different embodiments as come within the scope of the following claims.

We/I claim:

1. A unified oil filter and cooler comprising
a hollow cylindrical housing adapted to receive an annular filter media within the housing, the housing comprising a sidewall and a removable first end cap and a second end cap, the first and second end caps disposed on opposite ends of the side wall, wherein the side wall comprises a multiplicity of hollow rib members;
a baffle interior of the housing and in contact with the hollow rib members, wherein the baffle and each of the hollow rib members define separate rib flow channels;
a multiplicity of inlets disposed on the second end cap;
a first chamber defined by the baffle, a portion of inside walls of the rib members, and an inside wall of the second end cap, wherein the first chamber is in fluid communication with the multiplicity of inlets and with the separate rib flow channels;
a second chamber present when an annular filter media is positioned within the housing, the second chamber being interior of the baffle and in fluid communication with the separate rib flow channels, the second chamber comprising an annular space defined by an interior side of the baffle and an exterior surface of the annular filter media;
a third chamber present when an annular filter media is positioned within the housing and comprising a space defined by an interior surface of the annular filter media, wherein the third chamber is in fluid communication with the second chamber through the filter media; and, an outlet disposed on the second end cap, the outlet in fluid communication with the third chamber.

2. The unified oil filter and cooler of claim 1 wherein the ribs are V-shaped corrugations.

3. The unified oil filter and cooler of claim 1 wherein the housing is made from a material comprising aluminum.

4. The unified oil filter of claim 3, wherein the housing is extended or die cast.

5. The unified oil filter of claim 1 wherein the outlet is adapted to allow the unified oil filter and cooler to attach to a spin-on oil filter mount.

6. The unified oil filter of claim 1 wherein an annular filter media is positioned within the housing.

7. The unified oil filter of claim 1, wherein the second end cap is removably attached to the housing.

8. The unified oil filter of claim 7, wherein the second end cap is removably attached to the housing by means of multiple bolts.

9. The unified oil filter of claim 7, wherein the second end cap is removably attached to the housing by means of clamps.

10. The unified oil filter of claim 1, wherein the second end cap is permanently attached to the housing.

11. The unified oil filter of claim 1, wherein the second end cap is soldered to the housing.

12. A method of cooling and filtering engine oil comprising the steps of:
connecting the unified oil filter and cooler of claim 6 to an engine oil lubrication system such that the inlets and the outlet are in fluid communication with the oil lubrication system;
moving oil from the oil lubrication system into the filter housing via the inlets; and
moving the oil along a flow path that proceeds from the inlets, through the first chamber, through the rib flow channels, through the second chamber, through the annular filter media, through the third chamber, through the outlet back to the oil lubrication system,
wherein the oil is cooled by the heat exchange to outside air via the ribs.

13. The unified oil filter and cooler of claim 12 wherein the ribs are V-shaped corrugations.

14. The unified oil filter and cooler of claim 12 wherein the housing is made from a material comprising aluminum.

15. The unified oil filter of claim 12, wherein the housing is extended or die cast.

16. The unified oil filter of claim 12 wherein the outlet is adapted to allow the unified oil filter and cooler to attach to a spin-on oil filter mount.

17. The unified oil filter of claim 12, wherein the second end cap is removably attached to the housing.

18. The unified oil filter of claim 12, wherein the second end cap is permanently attached to the housing.
